(19) United States
(12) Patent Application Publication
(10) Pub. No.: US 2007/0083395 A1
(43) Pub. Date: Apr. 12, 2007

(54) Method and apparatus for a patient information system and method of use

(75) Inventors: Steven Lawrence Fors, Chicago, IL (US); Michael Thomas Randazzo, Cary, IL (US); Prashant Kumar Gupta, Bangalore (IN); Dave P. Murawski, Cary, IL (US)

Correspondence Address: MCANDREWS HELD & MALLOY, LTD, 500 WEST MADISON STREET, SUITE 3400, CHICAGO, IL, 60661, US

(73) Assignee: General Electric Company

(21) Appl. No.: 11/348,008

(22) Filed: Feb. 6, 2006

Related U.S. Application Data
(60) Provisional application No. 60/726,535, filed on Oct. 14, 2005.
(60) Provisional application No. 60/725,997, filed on Oct. 12, 2005.
(60) Provisional application No. 60/725,761, filed on Oct. 12, 2005.
(60) Provisional application No. 60/726,075, filed on Oct. 12, 2005.

(51) Int. Cl. G06F 19/00

(52) U.S. Cl. 705/3

(57) ABSTRACT

A system and method for managing information is disclosed. The method may include configuring a list of patients based on specified criteria and accessing patient data for a specific patient from the list of patients. The list of patients may include the name of at least one patient and various information associated with the patient, for example a status indicator and/or an alert indicator. Additionally, the name of a patient may be classified as confidential. The patients classified as confidential may be assigned an alias name to be displayed in the list of patients in place of the real name of the patient. The identity of a user may be associated with user permissions. The method may also include selecting a mode of operation based on a connection speed. The step of selecting may be performed by a user or by computer software.

### RELATED APPLICATIONS

This application claims the benefit of U.S. Provisional Application No. 60/726,535 filed Oct. 14, 2005 entitled “Patient Information System and Method of Use.” The '535 application is hereby incorporated by reference herein in its entirety. This application also claims the benefit of U.S. Provisional Application No. 60/725,997 filed Oct. 12, 2005, entitled “Access to Prior Visits of a Patient.” The '997 application is hereby incorporated by reference herein in its entirety. This application also claims the benefit of U.S. Provisional Application No. 60/725,761 filed Oct. 12, 2005, entitled “User-Selectable Low-Bandwidth Logon Option for Web-Based Clinical Information View Application.” The '761 application is hereby incorporated by reference herein in its entirety. This application also claims the benefit of U.S. Provisional Application No. 60/726,075 filed Oct. 12, 2005, entitled “Method of Protecting Patient Privacy in CIS Application.” The '075 application is hereby incorporated by reference herein in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention generally relates to managing medical information. Particularly, the present invention relates to a more efficient system and method for managing patient information.

Healthcare environments, such as hospitals or clinics, include clinical information systems, such as hospital information systems (HIS) and radiology information systems (RIS), and storage systems, such as picture archiving and communication systems (PACS). Information stored may include patient medical histories, imaging data, test results, diagnosis information, management information, and/or scheduling information, for example. The information may be centrally stored or divided at a plurality of locations. Healthcare practitioners may desire to access patient information or other information at various points in a healthcare workflow. For example, during surgery, medical personnel may access patient information, such as images of a patient's anatomy, that are stored in a medical information system. Alternatively, medical personnel may enter new information, such as history, diagnostic, or treatment information, into a medical information system during an ongoing medical procedure.

Current hospital and clinical information systems are inefficient and time consuming to use. For example, current hospital and clinical information systems provide a user with a select group of information for the patients on a patient list. Providing a set group of information is a “one size fits all” approach that displays similar parameters for the patients, regardless of medical condition. Typical information systems and methods are not configurable based on the preferences of a user or other criteria. Additionally, current patient information systems use fixed forms that generally set parameters, such as column representation and formatting, at the time of development. A patient list, for example, may generally display a fixed set of data for a list of patients. A user generally does not have the option to configure the patient list or configure the data displayed as part of the patient list. There is a need for a configurable patient information system and method to allow a user to customize a patient list and the data associated with the patient list.

In addition, current patient information systems and methods are inefficient and time consuming to use because the systems and methods are generally independent from a patient's historical information. Currently, it is difficult for a clinician to view information about prior visits for a patient and clinical data associated with prior visits. Accordingly, there is a need for a patient information system and method to allow a user to access a patient's historical information.

Furthermore, The Health Insurance Portability and Accountability Act (HIPAA) provides for a variety of requirements for the protection of the privacy of patients. Methods are needed to protect patient privacy in information systems applications for a variety of reasons including, for example, compliance with HIPAA requirements.

Moreover, normally users connect to a clinical information view (CIV) application over an internal hospital network or high bandwidth connection. Typically, a high bandwidth connection is desirable as the CIV may attempt to communicate or display large data files, such as images, to a user. On occasion, a user may connect to the a CIV using dial-up or other low bandwidth access. Such low bandwidth access may not be equipped to handle the large data files the CIV may attempt to communicate. Accordingly, the low bandwidth users may not be able to connect to the CIV application. Accordingly, current medical information systems and methods are inefficient, and time consuming. A need exists for a system and method that allows a user to configure a patient list and patient data. Such a system and method may provide for access to a patient's historical information. In addition, such a system and method can provide for protecting patient privacy.

### SUMMARY OF THE INVENTION

Certain embodiments of the present invention may include a method for managing information. The method may include configuring a list of patients based on specified criteria and accessing patient data for a specific patient from the list of patients. The patient data may include historical patient information for a specific patient. The list of patients may include the name of a patient. The list of patients may also include a status indicator and/or an alert indicator. The specified criteria may include the identity of a user. The identity of a user may be associated with permissions for the user. The name of a patient may be classified as confidential. The patients classified as confidential may be assigned an alias name to be displayed in the list of patients in place of the real name of the patient. The method may also include selecting a mode of operation based on a connection speed. The step of selecting may be performed by a user.

Certain embodiments of the present invention may include a system for managing information. The system may include a computer unit for manipulating data. The computer unit may execute computer software for configuring a list of patients based on specified criteria and access patient data for a specific patient from the list of patients. The specified criteria may include the identity of a user, the identity of a user being associated with permissions for the user. The list of patients may include a status indicator and/or an alert indicator. The system may also include an input unit for receiving input from a user and a display unit for displaying information to a user. The patient data may include historical patient information for a specific patient. The list of patients may include the name of a patient, the name of a patient may be classified as confidential. Patients classified as confidential may be assigned an alias name to be displayed in the list of patients in place of the real name of the patient. The computer software may select a mode of operation based on a connection speed. Alternatively, a user may select a mode of operation based on a connection speed.

Certain embodiments of the present invention include a computer-readable storage medium including a set of instructions for a computer. The set of instructions may include a configuration routine for configuring a list of patients based on specified criteria. The set of instructions may also include an accessing routine for accessing patient data for a specific patient from a list of patients. The patient data may include historical patient information for a specific patient.

### BRIEF DESCRIPTION OF THE DRAWINGS

FIG. 1 illustrates an example of a system that may be used in accordance with an embodiment of the present invention.

FIG. 2 illustrate a method that may be used in accordance with an embodiment of the present invention.

FIG. 3 illustrates a screenshot of an application used in accordance with an embodiment of the present invention.

FIG. 4 illustrates a screenshot of an application used in accordance with an embodiment of the present invention.

FIG. 5 illustrates a screenshot of an application used in accordance with an embodiment of the present invention.

FIG. 6 illustrates a screenshot of an application used in accordance with an embodiment of the present invention.

FIG. 7 illustrates a screenshot of an application used in accordance with an embodiment of the present invention.

FIG. 8 illustrates a screenshot of an application used in accordance with an embodiment of the present invention.

FIG. 9 illustrates a screenshot of an application used in accordance with an embodiment of the present invention.

FIG. 10 illustrates a screenshot of an application used in accordance with an embodiment of the present invention.

FIG. 11 illustrates a screenshot of an application used in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

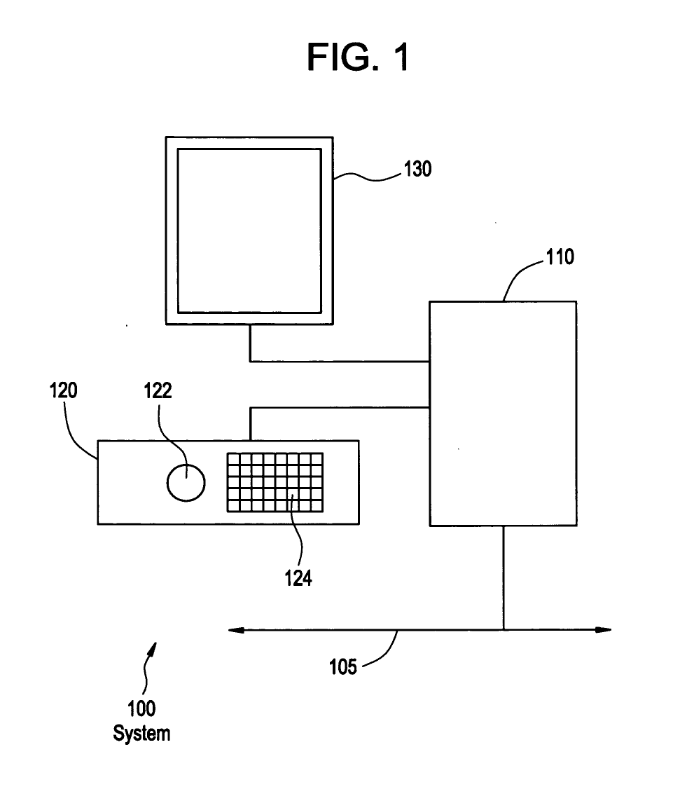

FIG. 1 illustrates a system 100 for manipulating and displaying medical information. The system 100 includes a computer unit 110. The computer unit 110 may be any equipment or software that permits electronic data and/or electronic medical images, such as x-rays, ultrasound, CT, MRI, EBT, MR, or nuclear medicine for example, to be electronically acquired, stored, or transmitted for viewing and operation. The computer unit 110 may receive input from a user. The computer unit 110 may be connected to other devices as part of an electronic network. In FIG. 1, the connection to the network is represented by line 105. The computer unit 110 may be connected to network 105 physically, by a wire, or through a wireless medium. The computer unit 110 may represent any electronic hardware and/or software that may be used in any embodiment of the present invention.

The system 100 also includes an input unit 120. The input unit 120 may be a console having a track ball 122 and keyboard 124. Other input devices may be used to receive input from a user as part of the input unit 120. For example a microphone may be used to receive verbal input from a user. The system 100 also includes at least one display unit 130. The display unit 130 may be a typical computer display unit. The display unit 130 may be in electrical communication with the computer unit 110 and input unit 120. In an embodiment, the display unit 130 may represent multiple display units or display regions of a screen. Accordingly, any number of display units may be utilized in accordance with the present invention.

The computer unit 110 and display unit 130 may be separate units or be part of a single unit. In addition, the computer unit 110 may be part of a larger computer system. In the case of separate units, the display unit 130 may be in electrical communication with the computer unit 110. The components of the system 100 may be single units, separate units, may be integrated in various forms, and may be implemented in hardware and/or in software.

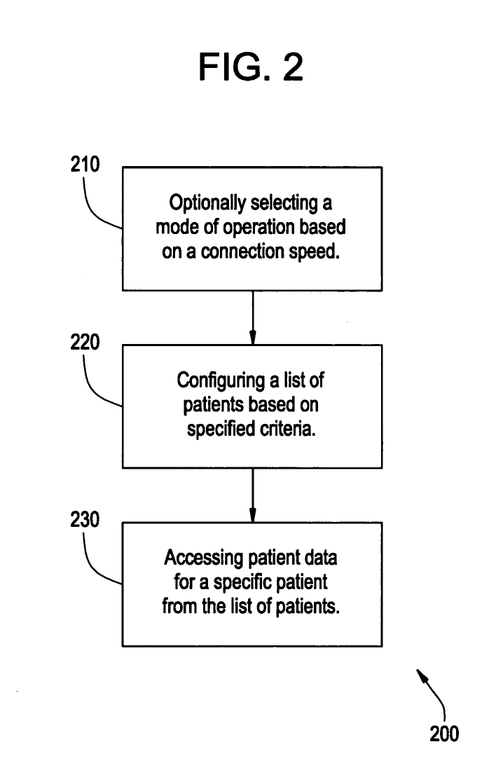

FIG. 2 illustrates a method 200 for managing patient information in accordance with an embodiment of the present invention. The method 200 may be executed by computer software residing on computer unit 110. Alternatively, the method 200 may be executed by computer software residing on a computer system, such as a server or database, other than the computer unit 110. The computer unit 110, however, may be in communication with the computer system or server executing and/or storing the computer software for the method 200 via the network 105.

The method 200 may be used for managing patient information. Certain embodiments of the present invention provide for a configurable patient list. A patient list, and the data displayed in the patient list, may be customized and/or configured based specified criteria. In one embodiment, the patient list may be configured based on the role of the user. In another embodiment, the patient list may be configured based on user settings. Generally, any manner of configuring a patient list may be used in accordance with an embodiment of the present invention.

At step 210 of method 200, a mode of operation may optionally be selected based on connection speed. The mode of operation to be selected is generally a choice between a “low bandwidth mode” and a “normal bandwidth mode.” Upon selection of the “low bandwidth mode,” various features generally designed to use a higher bandwidth, such as features including images, are disabled.

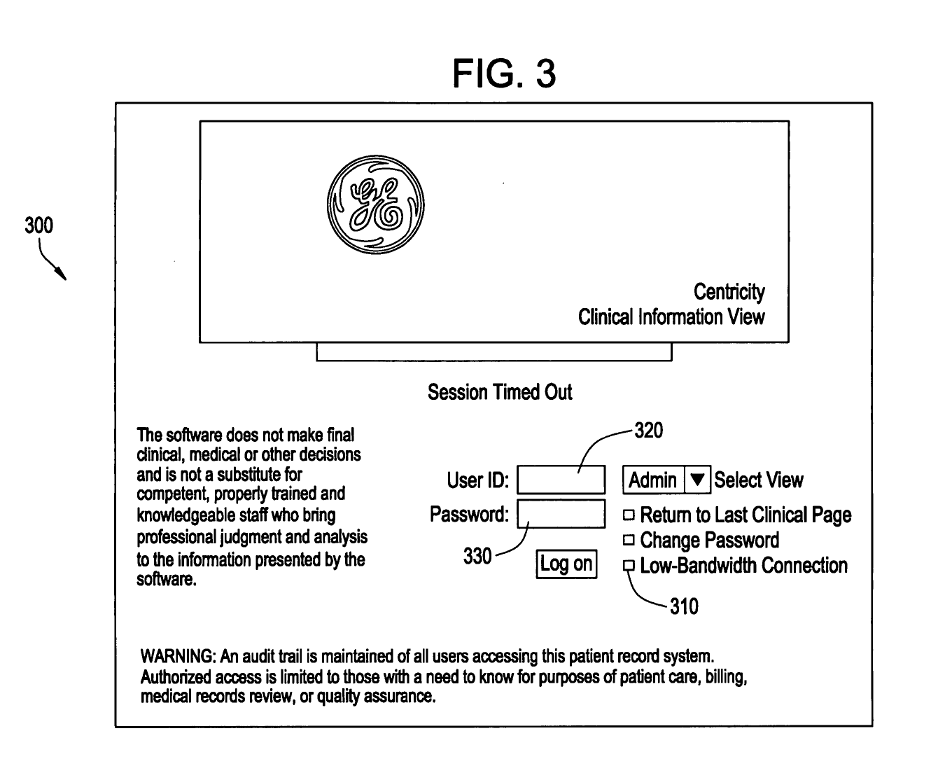

FIG. 3 illustrates and example of the step 210. FIG. 3 illustrates a screen shot 300 that may be used in accordance with an embodiment of the present invention. The screenshot 300 illustrates an embodiment in which the user logs onto the clinical information view (CIV) application with a correct User ID 320 and password 330 pair. Screenshot 300 also illustrates various checkboxes for a user to input information during logon. One of the checkboxes is checkbox 310. Checkbox 310 allows a user to select a “Low Bandwidth Connection” mode. Upon selection of the checkbox 310, a user indicates to the system that the communication, at least in part, may be conducted over a slower connection than is optimal for operating the CIV application.

In an embodiment, upon indicating to the CIV application that a “low bandwidth” condition may exist, at least one high-bandwidth application may be disabled, replaced, and/or adapted with a low-bandwidth application to provide a more efficient low-bandwidth user interaction. That is, the low-bandwidth option may, for example, allow the user to opt for certain features which generally require high-bandwidth to function reasonably well to be turned off in favor of low-bandwidth alternatives. For example, a Results Review Applet may be turned off in favor of the low-bandwidth-friendly Results Review Lite feature.

Under normal circumstances, when the user logs on, certain activities may start occurring in the background to initialize the data for the high-bandwidth Results Review Applet option. These may start to occur even before the user attempts to access Results Review. This may occur, for example, to give the user reasonable performance when the user does access the feature. In an embodiment, with the low-bandwidth option indicated, these background activities may cease to occur, allowing the system to perform more optimally under low-bandwidth conditions.

In certain embodiments, the system may be put into a low-bandwidth mode by the CIV application or other software, and it may be put into a low-bandwidth mode at a time other than logon. For example, the system may be put into a low-bandwidth mode without a user specifying at logon, for example by the checkbox 310. In an embodiment, the system may be put into a low-bandwidth mode at later point in the session, after logon. Additionally, the system may be put into a low-bandwidth mode by a user, or by the system itself. In certain embodiments, the system may monitor the connection speed of the user's computer with the system and switch to a low bandwidth mode if the connection speed is below a threshold level. Moreover, in an embodiment, when the system is configured to disable the Results Review Applet, for example low-bandwidth is the implied default behavior, then the low-bandwidth option may be omitted from the logon page and the system behaves in low-bandwidth mode by default, with no option to switch to the Results Review Applet.

Step 210 of the method 200 is optional. An offering of a low-bandwidth option, regardless of whether the option is offered to the user or the software, is not required to execute the remainder of the method 200. Certain embodiments of the invention do not utilize a “low bandwidth connection” mode. In such embodiments, a user may logon the CIV application using a User ID 320 and a Password 330. The User ID 320 and Password 330 may determine whether the user has permission to access the system. The User ID 320 and Password 330 may also identify the user, for example identify the permissions the user has within the system, the preferences set up by a user, and a custom work screen or patient list for the user. For example, a user who is a nurse may logon to the CIV application using a User ID 320 and Password 330 as shown in FIG. 3. In an embodiment, a user may optionally check checkbox 310. In another embodiment, the user does not have the option to check checkbox 310 as the system does not offer a “low bandwidth mode.” Once the user submits his User ID 320 and Password 330, a custom work screen may be displayed for the nurse user. A different nurse user may have a different work screen. A doctor user may have a different set of permissions and have an entirely different work screen from a nurse user. Accordingly, the information displayed to a user after logging onto the CIV system may be based on the identity of the user.

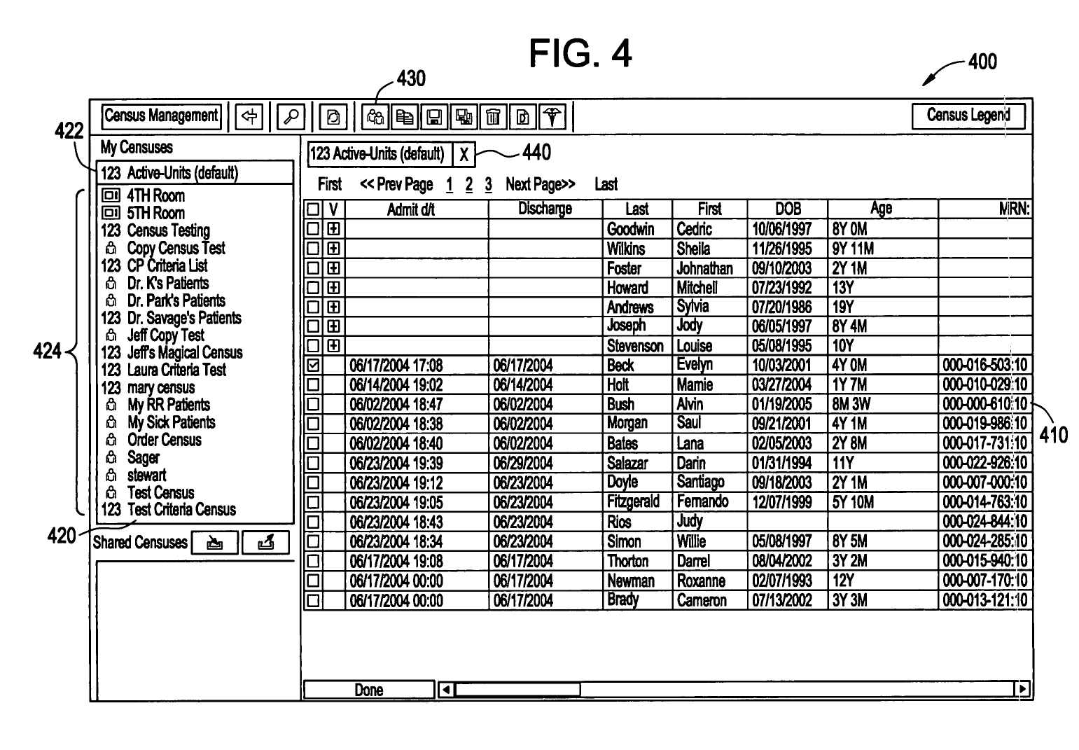

Step 220 of the method 200 illustrates configuring a list of patients based on specified criteria. FIG. 4 illustrates a screenshot 400 of an example work screen that may be displayed to a user. Continuing with the example from FIG. 3, the screenshot 400 may be the work screen that may be displayed to a user after the user logs onto the CIV application in screen shot 300.

The work screen may include a patient list 410, a census box 420, and various other tools 430 for operating the software. The patient list 410, as illustrated in FIG. 4, displays information about patients in a horizontal manner. For example, the columns represent information about a particular patient, such as the date of admission, the discharge date, the patient's name, date of birth, age, or other information about the patient. The information about the patient may also include medical information. The patient list 410 allows a user to select a patient, for example, by a checkbox or other mode, such as for example, using a computer mouse. The selected patient may be highlighted as shown in FIG. 4.

The amount of available information displayed in the patient list 410 may be configured. The amount of available information displayed in the patient list 410 may vary based on, for example, the user. For example, a doctor may view all available patient information whereas a nurse may view less than all available patient information. The amount of information displayed in the patient list 410 may also vary based on user preference. A first user may wish to display subset A of information and a second user may wish to display subset B of information. The information displayed in the patient list may be pre-configured or dynamically configured.

The number or grouping of patients displayed as part of the patient list may also be configured. A certain setting may display all patients. Various groupings of patients may be configured. For example, a user may wish to group patients based on the doctor assigned to the patients. As another example, a user may wish to group the patients based on location. Any possible grouping of patients or patient information may exist.

The census box 420 illustrates the currently available configurations of the patient list 410. For example, the column beginning with “Active-Units (default)” 422 indicates the currently available configurations of the patient list 410. The highlighted configuration 422 in the census box 420 indicates the currently displayed configuration. In the example of FIG. 4, the highlighted configuration 422 is the “Active-Units (default)” configuration. Additionally, the tab 440 also indicates the currently displayed information. The “Active-Units (default)” 422 configuration may represent a global representation of patients, such as all patients in the hospital, or may represent all patients in a particular ward, or other grouping of patients. The default condition may be different for each user and may be configurable based on specified criteria.

In general, the configurations in the census box 420 are based on some predefined criteria. For example, the “Active-Units (default)” 422 configuration may be a configuration based on criteria to illustrate all patients on a particular floor of a hospital. Other criteria may include, for example, floor, room, unit, location, medicine, person's a user is responsible for, and/or condition. Accordingly, any criteria may be used to configure the patient list 410.

Additionally, the configurations in the census box 420 may be partially grouped by icons 424. For example, different icons may represent different types of lists, such as criteria-based lists, user-based lists, and room-based lists. A user may create or define their own patient list 410 and an icon may identify the list as user created. A user-based list may be, for example, a list individualized to a specific physician or nurse.

The patient list 410 may be configured to allow access to a variety of information and/or functionality based on, for example, the user, type of user, or location. Access may include, for example, order review, a document viewer, and order entry. Access to certain information may be restricted based on, for example, permissions configured for the user, authentication, specific user, type of user, or location. In an embodiment, the patient list 410 displays data to which the user has access.

In an embodiment, the patient list 410 may be configured to show what is new since a prior point in time. New information may include, for example, new patients on the list, new lab results, and new orders. The prior point in time may be, for example, a fixed period (e.g., 1 day) or since the user last viewed the list. Certain embodiments provide for a dynamically updateable and modifiable patient information center linking an up-to-date patient list 410 with a variety of related resources. For example, the screen may dynamically refresh based on a change in the data. The patient list 410 may always display the latest data. For example, an individual column may be updated when new lab results are available for a patient. In an embodiment, the data for the patient list 410 may be pushed to the patient list 410 rather than polled. For example, individual data may be updated by pushing the data to the patient list 410. In an embodiment, no user interaction is required to refresh the patient list 410. In an embodiment, the patient list may be updated based on a user request and/or periodically.

In an embodiment, the user may search the patient list 410 without creating a new patient list. The search may be performed, for example, by first name, last name, visit, record number, physician, and unit. The search criteria may be configured to be displayed on the patient list 410. The criteria that may be searched may be limited based on, for example, user, role, and patient. The searchable criteria may be configured. Additionally, certain columns of the patient list 410 may be edited by the user. A user may assign values to columns directly from the patient list 410. For example, a user may specify the attending physician for a patient in the attending physician column of the patient list 410. The patient list 410 can be configured to specify which columns may be edited by the user.

A user may select a patient from the patient list 410 to obtain information about the patient. As is further explained below, a user may select a patient and bring up a secondary menu to view specific data about a patient.

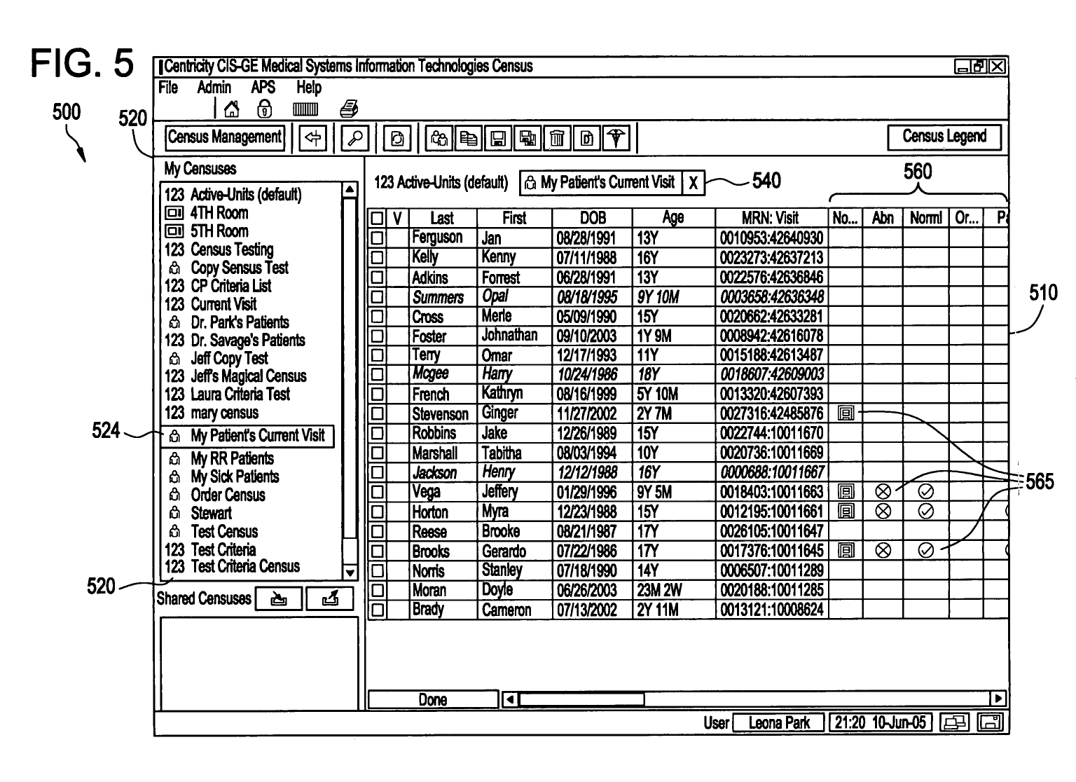

FIG. 5 illustrates a work page 500 that shows the creation of a new patient list 510 called “My Patient's Current Visit” from the work page 400. A patient list may be created by, for example, by selecting patients of interest based on criteria and saved as a patient based-list. The criteria for this example configuration may include that the user has responsibility for the patients on the list and that the data displayed is for the patient's current visit. The new patient list 510 is added to the census box 420 to create census box 520 and an icon 524 identifies the new patient list 510 as a user created patient list. A new tab 540 at the top of the patient list 510 identifies the currently displayed patient list 510. The work page 500 also illustrates a configuration of the columns on the patient list 510. As compared with the patient list 410, the “admit d/t” and “discharge” columns have been removed from patient list 510. Various other columns 560 have been added to the patent list 510.

The columns 560 may display various icons 565 to display information about the patient, such as the condition of the patient or results from a test. A user may “click” on an icon 565 and test results or other information may be displayed. In an embodiment, indicators, such as icons 565, may be used in the patient list 510 to notify a user that there are, for example, notes, abnormal lab results, normal lab results, panic lab results, and/or new orders. A user may select an icon 565 to go to more detailed information regarding whatever the icon represents. For example, selecting an icon indicating there are notes for the patient would display the notes associated with the patient.

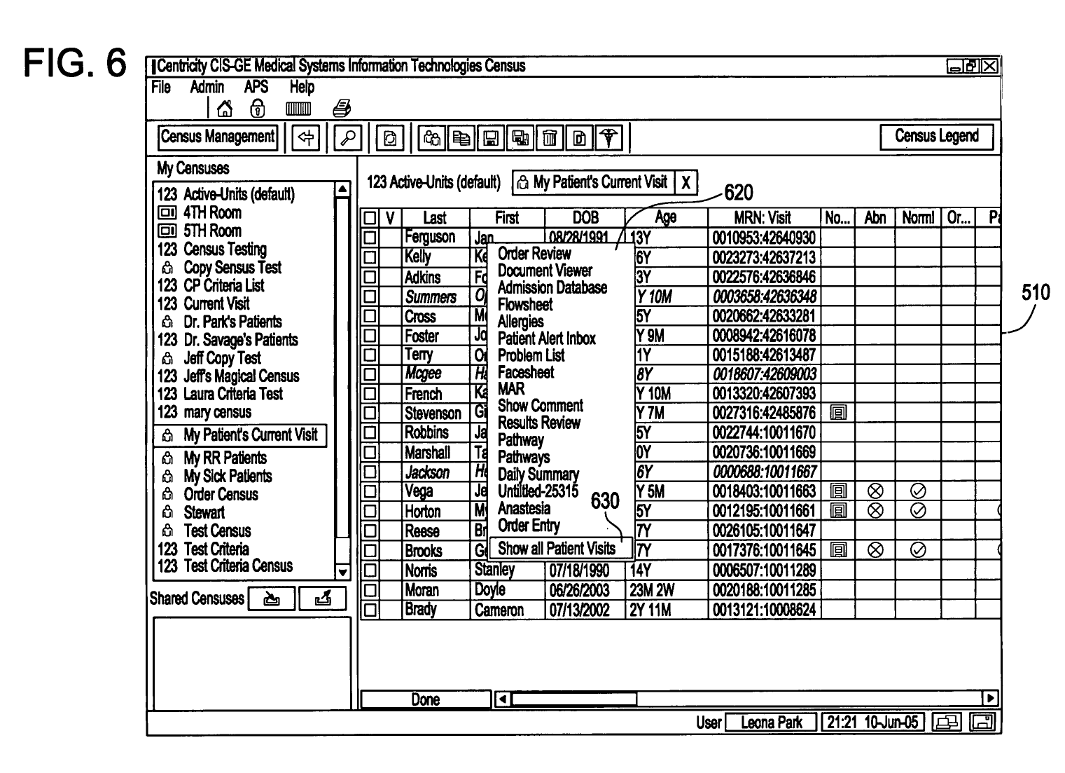

FIG. 6 illustrates selecting a patient from the patient list 510. As is explained above, a patient may be selected from the patient list 510 and information about the patient may be displayed. In an embodiment, a user may select a patient and display a secondary menu 620. In an embodiment, the secondary menu 620 is a pop-up menu that may be displayed as a result of selecting a patient from the patient list 610 and “right clicking” on the row of the patient in the patient list 510. Other techniques of selecting a patient may be used, such as voice commands or touch screen input. Accordingly, any input technique may be used to select a patient and display a secondary menu 620.

As illustrated in FIG. 6, the secondary menu 620 may illustrate a variety of configurations for available data for the selected patient. For example, the configurations shown in FIG. 6 on the secondary menu 620 include an order review; document viewer; admission database; flowsheet; allergies; patient alert inbox; problem list; facesheet; MAR; show comment; results review; pathway; pathways; daily summary; untitled-25315; anastesia; order entry; and show all patient visits. The configurations on the secondary menu 620 may be configured by a specified criteria and may be user defined or defined by the computer software.

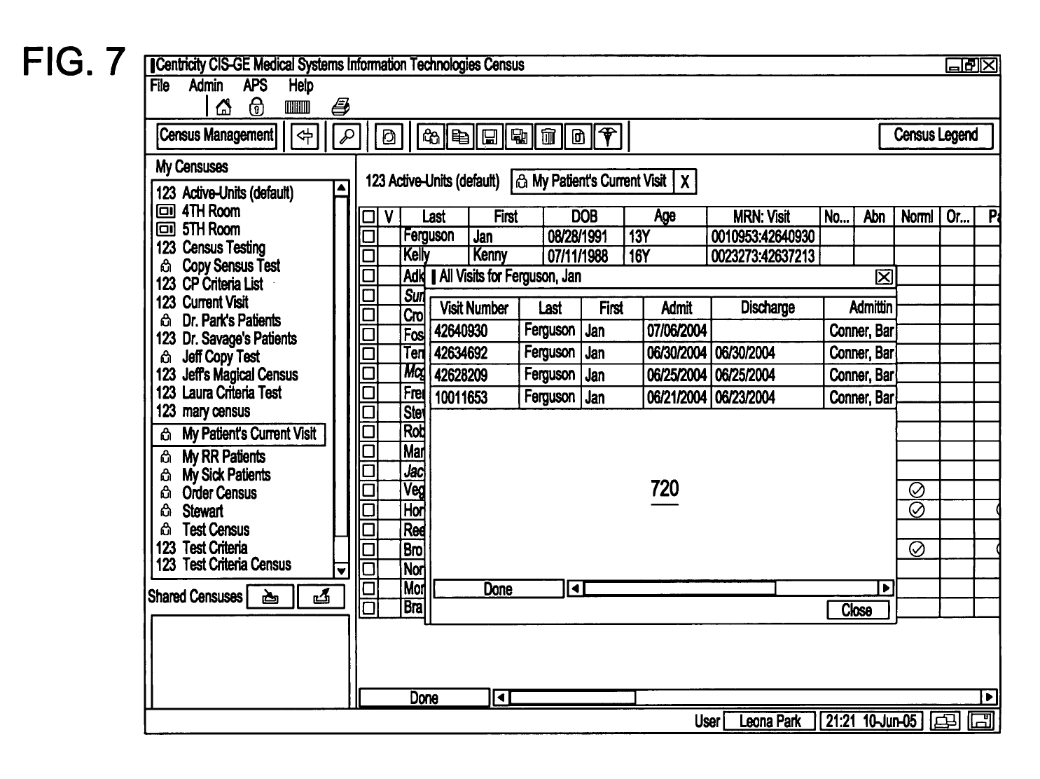

In the embodiment shown in FIG. 6, one of the configurations for data includes a “Show all Patient visits” 630. A user may select the “Show All Patient visits” option 630. Upon selection of option 630, the data may be displayed in an “all visits” pop-up window 720, as is shown in FIG. 7. The data may also be displayed on a new screen, the same window, or some other display configuration. In an embodiment, the “all visits” window 720 may be organized by patient visit. For example, one row may represent one visit of a patient. The “all visits” window 720 may display a chronological history of patient visits. The user may display repeat visits and select an entry to show details of those visits.

Continuing with the example above, a user may select a prior visit from the “all visits” window 720. In an embodiment, upon selection, the user may be given access to general information about the patient and information specific to that particular visit. For example, the patient information may include one or more of: lab results, orders information, flowsheets, admission information, assessments, allergies, and/or problems.

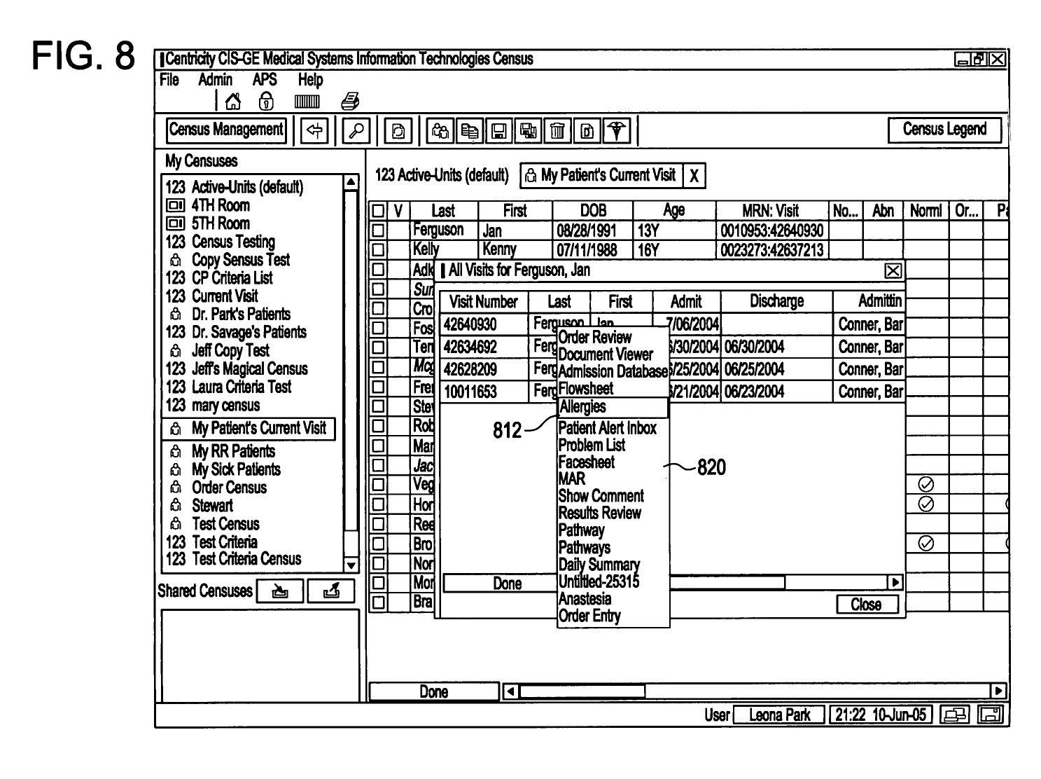

As illustrated in FIG. 8, a user may also display a secondary menu 820 from the “all visits” window 720. In the example shown, the secondary menu 820 is similar to the secondary menu 620 with the exception that the secondary menu 820 does not have the “Show all Patient visits” 630 option. Accordingly, a user may view a configuration of patient data from the “all visits” window 720. The secondary menu 820 may be displayed in a similar manner as the secondary menu 620 was displayed. In an embodiment, the secondary menu 820 may be displayed by “right clicking” a computer mouse after selecting the patient. As the “all visits” window 720 has data only for a single patient, a user may “right click” anywhere on the window to display the secondary menu 820.

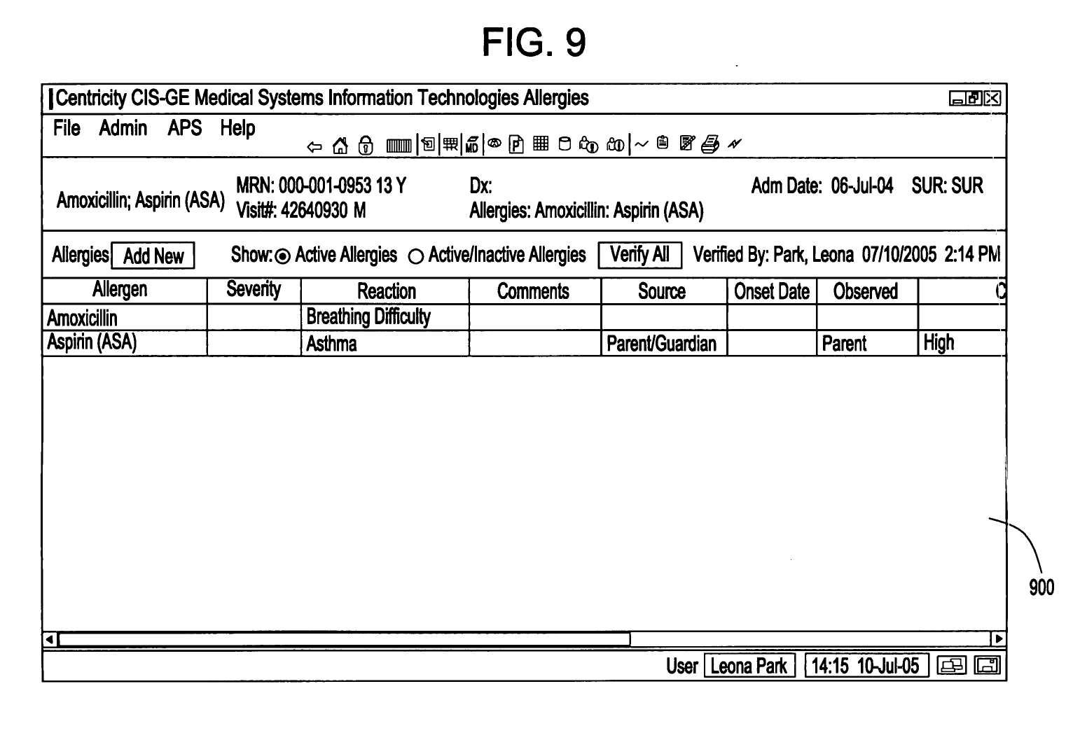

As shown in FIG. 8, a user has selected the “Allergies” category 812 to view a patient's allergies. Continuing with the example above, FIG. 9 illustrates an allergy pop-up page 900. The allergy pop-up page 900 illustrates the allergies of the patient. A selection of the “allergies” category 812 from the secondary menu 620 may also result in display of the allergy pop-up page 900. In such a manner as described above, a user may navigate and configure information about multiple patients in a more efficient manner.

The patient information system and method described above provide a user with a great amount of information about a patient. The ease of use of the system and method may allow a user to have access to all sorts of information about a patient. In order to protect the privacy of the patient, however, the patient list may be formatted for HIPAA compliance. A patient list that supports privacy may be based on, for example, a pre-configured list of columns. A user may select data columns from an available list to provide patient privacy. A patient list may be requested, defined, declared, and/or selected to be de-identified. That is, the patient list may not show identifying information for a patient.

In certain embodiments of the present invention, patients may be marked as confidential. For example, a flag may be received from the hospital's information system (HIS). The flag may come over an Admission, Discharge, and Transport system (ADT), for example. The flag may be received from a component of the HIS, for example. As another example, a patient may be marked as confidential in the system.

In an embodiment, when a patient is marked and/or flagged confidential, one or more staff members previously, currently, or subsequently assigned to the patient as, for example, caregivers, are granted access to the patient and/or the patient's data. Individual staff members, or groups of staff members, may be granted access to the patient. These individuals or groups may be granted access based at least in part on role, for example.

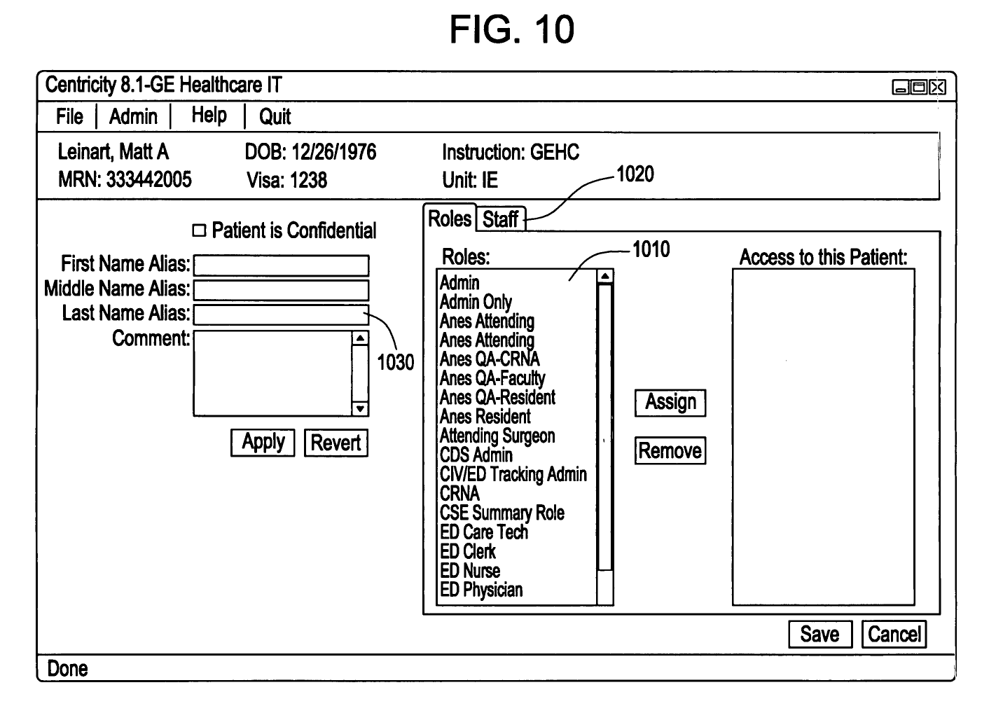

In certain embodiments, when a patient is marked as confidential, an alias name or identifier is assigned to the patient. FIG. 10 illustrates an administration screen for managing patient confidentiality and assigning access information. Box 1010 lists groupings of individuals that may have access to the patient's information. As displayed, individuals “roles” may be selected, such as nurses or doctors. Also shown is an additional tab 1020 illustrating “staff.” The 1020 “staff” tab may include the names of staffed individuals and selected individuals may be granted access to the patient information.

Section 1030 of FIG. 10 has a section for the “alias” of the patient. The “alias” of the patient may be a name or identifier assigned to the patient other than her real name. The “alias” may be auto-assigned or assigned by a user. The auto-assigned name may come from, for example, a list of alias names that has been setup in the system. As another example, the auto-assigned name or identifier may be generated dynamically.

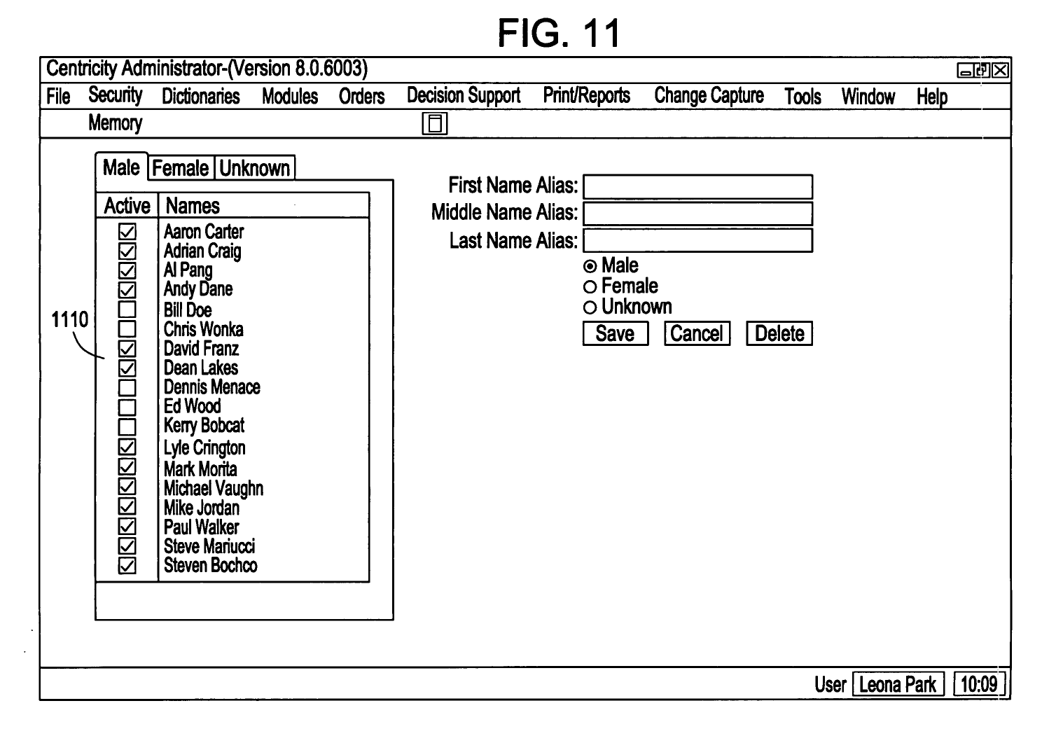

FIG. 11 illustrates an administration screen for a pool of patient aliases. Box 1110 represents the pool of alias names. A check next to the name represents that the name is active and may not be assigned to the patient of interest.

In certain embodiments, a confidential patient may be displayed in the system using the patient alias instead of their real name. For example, users that have not been granted access to the patient may be shown the patient alias instead of the patient's real name. In addition, in an embodiment, only staff that have been granted access to the patient may open the patient's medical record. In certain embodiments, when a patient has been marked confidential, the system may also control whether, for example, printing and/or reporting on this patient should use the patient's legal name or the alias or both. In an embodiment, this may be based at least in part on who is trying to print and/or access the record. In certain embodiments, the application may not return confidential patients when searching by, for example, legal name. In an embodiment, the system may allow searching by aliases.

The system and method described above may be carried out as part of a computer-readable storage medium including a set of instructions for a computer. The set of instructions may include a configuration routine for configuring a list of patients based on specified criteria. The set of instructions may also include an accessing routine for accessing patient data for a specific patient from the list of patients. The patient data may include historical patient information for a specific patient.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for managing information, said method comprising:
configuring a list of patients based on specified criteria; and
accessing patient data for a specific patient from said list of patients.

2. The method of claim 1, wherein said patient data includes historical patient information for a specific patient.

3. The method of claim 1, wherein said list of patients may include the name of a patient, said name of a patient may be classified as confidential.

4. The method of claim 3, wherein said patients classified as confidential may be assigned an alias name to be displayed in said list of patients in place of the real name of said patient.

5. The method of claim 1, further including the step of selecting a mode of operation based on a connection speed.

6. The method of claim 5, wherein said step of selecting is performed by a user.

7. The method of claim 1, wherein said specified criteria may include the identity of a user, said identity of a user being associated with permissions for said user.

8. The method of claim 1, wherein said list of patients includes a status indicator.

9. The method of claim 1, wherein said list of patients includes an alert indicator.

10. A system for managing information, said system comprising:
a computer unit for manipulating data, said computer unit executing computer software for configuring a list of patients based on specified criteria and accessing patient data for a specific patient from said list of patients;
an input unit for receiving input from a user; and
a display unit for displaying information to a user.

11. The system of claim 10, wherein said patient data includes historical patient information for a specific patient.

12. The system of claim 10, wherein said list of patients may include the name of a patient, said name of a patient may be classified as confidential.

13. The system of claim 12, wherein said patients classified as confidential may be assigned an alias name to be displayed in said list of patients in place of the real name of said patient.

14. The system of claim 10, wherein said computer software selects a mode of operation based on a connection speed.

15. The system of claim 10, wherein a user selects a mode of operation based on a connection speed.

16. The system of claim 10, wherein said specified criteria may include the identity of a user, said identity of a user being associated with permissions for said user.

17. The system of claim 10, wherein said list of patients includes a status indicator.

18. The system of claim 10, wherein said list of patients includes an alert indicator.

19. A computer-readable storage medium including a set of instructions for a computer, the set of instructions comprising:
a configuration routine for configuring a list of patients based on specified criteria; and
an accessing routine for accessing patient data for a specific patient from said list of patients.

20. The set of computer instructions of claim 19, wherein said patient data includes historical patient information for a specific patient.
